(19) United States
(12) Patent Application Publication
(10) Pub. No.: US 2025/0198794 A1
(43) Pub. Date: Jun. 19, 2025

(54) CLOUD-BASED SENSING AND CONTROL USING AUTOMOTIVE RADAR NETWORK

(71) Applicant: B.G. Negev Technologies Ltd., at Ben-Gurion University, Beer Sheva (IL)

(72) Inventors: Joseph TABRIKIAN, Tel Aviv (IL); Igal BILIK, Rehovot (IL); Shahar VILLEVAL, Tzoran (IL)

(21) Appl. No.: 18/846,007

(22) PCT Filed: Mar. 15, 2023
(86) PCT No.: PCT/IL2023/050272

§ 371 Date: Sep. 11, 2024

Related U.S. Application Data
(60) Provisional application No. 63/319,785, filed on Mar. 15, 2022.
(60) Provisional application No. 63/408,101, filed on Sep. 20, 2022.

(51) Int. Cl. G01C 21/00; G01S 7/36; G01S 13/931; G08G 1/01; G08G 1/0969

(52) U.S. Cl. CPC G01C 21/3841; G01S 13/931; G08G 1/0112; G08G 1/0125; G08G 1/0969; G01S 7/36

(57) ABSTRACT

A system for generating and providing an enriched global map to subscribed moving platforms (such as vehicles, bikes, drones, scooters or pedestrians), comprising a plurality of sensors installed on a plurality of moving platforms (such as vehicles) in a given area, where each sensor views a target of an object of interest from a different angle; a data network for collecting data containing detection maps from the sensors; a central processor connected to the data network, which is adapted to generate an enriched and complete high-resolution global map of the given area by jointly processing and fusing the collected data; unify the detection capabilities of the moving platforms; transmit, over the data network, the complete high-resolution global map to at least one moving platform.

### FIELD OF THE INVENTION

The present invention relates to the field of automotive radar networks. More specifically, the invention relates to a cloud-based system for sharing sensed information collected by networked sensors of moving (e.g., an automotive radar) or stationary (e.g., ground radar) platforms.

### BACKGROUND OF THE INVENTION

Driving safety is one of the major concerns in modern life, particularly when roads become more and more congested due to the increasing number of vehicles that share them, as well as to new low-profile vehicles, such as electric bikes and scooters. The presence of pedestrians also introduces a risk for drivers, who hardly can identify them in time.

Modern Advanced Driver-Assistance Systems (ADAS-groups of electronic technologies that assist drivers in driving and parking function) provide assistance to the driver, based on a combination of data collected from sensors, such as night and day video footages and radar signals that are processed together and provide visual information to the driver regarding other moving vehicles in his vicinity, as well as stationary and moving objects (e.g., pedestrians). Visual sensors are also limited in their ability to provide information due to bad visibility conditions, such as fog, dust rain, etc. In this case, radar signals that are reflected from the scanned objects may provide the missing information, since they are not sensitive to bad visibility conditions. However, these sensors are effective only when there is a line of sight between the vehicle and the object (the target). This limitation is even more severe in urban areas, where the line of sight is blocked by buildings.

It is therefore an object of the present invention to provide a method and system for overcoming visibility limitations of drivers, based on sharing data acquired by a plurality of sensors from different aspects of an object.

It is another object of the present invention to provide a method and system for overcoming visibility limitations of drivers, based on data that is acquired and jointly processed in real-time in dense urban scenes under non-line of sight conditions.

It is a further object of the present invention to provide a method and system for providing traffic information of the vehicle locations within a lane with a resolution of road lanes to thereby allow vehicles to autonomously navigate between the lanes.

It is still another object of the present invention to provide a method and system for providing additional information to vehicles, on top of their individual sensing capabilities.

It is yet another object of the present invention to provide a method and system for providing additional information to vehicles, using simpler sensors with lower accuracies and resolution and lower transmit power.

Other objects and advantages of the invention will become apparent as the description proceeds.

### SUMMARY OF THE INVENTION

A method for generating and providing an enriched global map to subscribed moving platforms (such as vehicles, bikes, drones, scooters or pedestrians), comprising:
a) collecting data containing detection maps from sensors (such as radars, cameras, LiDARs) installed on a plurality of moving platforms in a given area, where each sensor views a target of an object of interest from a different angle;
b) generating an enriched and complete high-resolution global map of the given area by jointly processing and fusing the collected data that unifies the detection capabilities of the moving platforms; and
c) transmitting the complete high-resolution global map to at least one moving platform.

Joint processing and fusing of the collected data may be done by a central processor, a remote server or a computational cloud, being in communication with the plurality of moving platform over a wireless data network.

Data fusion may be done, based on the construction of global likelihood function of various objects in the area, while considering the accuracy of the GPS-based position and orientation of each moving platform, and the latency of the data transferred from each moving platform to the computational cloud.

The collected data may be in the form of point clouds.

The fusion efficiency may be increased by measuring the relative location of detected proximal objects.

High accuracy may be obtained by measuring the relative location of each moving platform and performing fast synchronization between the signals.

Data fusion may be used to improve the range resolution and the angular resolution. Preferably, data collection and processing are performed in real-time.

The enriched global map may include an alert in the form of a visual indication or a voice indication.

The alert may appear as a blinking icon on the enriched global map, accompanied with a voice alert in the form of a beep or a voice announcement.

The enriched global map is used for automatic hazard detection on the road.

Data may be collected from automotive radars, infrastructure radars and other moving radars.

The data stream transmitted from each moving platform to the central processor may include a time stamp with predefined accuracy.

The data stream may further include one or more of the following:
a list of detected targets;
a confidence level of the detected targets;
a GPS position of the sensor;
odometry or other sensors;
the sensor's orientation.

Data fusion, may be used for identifying and classifying targets and providing accurate positioning of moving platforms and objects.

Traffic information in the resolution of road lanes may be provided, for allowing vehicles to autonomously navigate between the lanes.

The fused information may be used to evaluate the confidence level of the radar in the fusion process, by assessing bias and variance for the measurements of each radar regarding range, azimuth, elevation and Doppler estimations and to provide a performance assessment of the radars over time by comparing the detections from the different radars to the fused information.

The locations and velocities of the crossing vehicles may be used to predict the exact time of the presence of the vehicle in a junction and provide alerts.

The fused information may be used to evaluate precipitation rates (of rain or snow) at different positions by estimating the propagation loss and to detect vacant parking slots, along the vehicle's path.

Information from adjacent vehicles and infrastructure radars may be used to provide sensing information to all vehicles in the area, including vehicles that do not have sensing capabilities.

A system for generating and providing an enriched global map to subscribed moving platforms (such as vehicles, bikes, drones, scooters or pedestrians), comprising:
a) a plurality of sensors installed on a plurality of moving platforms in a given area, where each sensor views a target of an object of interest from a different angle;
b) a data network for collecting data containing detection maps from the sensors;
c) a central processor (e.g., a server or a computational cloud), connected to the data network, for:
   c.1) generating an enriched and complete high-resolution global map of the given area by jointly processing and fusing the collected data;
   c.2) unifying the detection capabilities of the moving platforms; and
   c.3) transmitting, over the data network, the complete high-resolution global map to at least one moving platform.

### BRIEF DESCRIPTION OF THE DRAWINGS

The above and other characteristics and advantages of the invention will be better understood through the following illustrative and non-limitative detailed description of embodiments thereof, with reference to the appended drawings, wherein:

FIG. 1 illustrates a situation when buildings block the visibility of a driver in an urban area;

FIGS. 2A and 2B show the field of view of two vehicles which are truncated by buildings in an urban area;

FIG. 3 shows the result of data fusion of the radar measurements (or radar map) taken by two vehicles from different aspects;

FIGS. 4a and 4b illustrate the advantage of sharing radar maps and data fusion, in terms of improved resolution, both in range and angular resolution (azimuth); and

FIG. 5 illustrates the data flow in the system, according to an embodiment of the invention.

### DETAILED DESCRIPTION OF EMBODIMENTS OF THE INVENTION

The present invention relates to a system for cloud-based joint processing of the data collected by multiple automotive radar devices (or by other sensors) on multiple geographically distributed moving platforms (such as vehicles, bikes, drones, scooters or pedestrians) to create high-resolution, accurate, and reliable sensing of objects in the road environment.

This invention proposes cloud-based joint processing of the data collected by multiple sensors, such as radars, cameras, and LiDARs (Light Detection And Ranging-a remote measurement technique based on the analysis of the properties of a beam of light reflected back to its emitter), which are mounted on multiple geographically distributed infrastructure and mobile platforms (ground or aerial vehicles), which can be manned or unmanned to create a high-resolution, accurate, and reliable environment sensing (detection, localization, and classification of all objects surrounding platforms in the network).

The system is based on obtaining processed detections (including GPS-based position) from a plurality of networked sensors of subscribed moving or stationary platforms in a given area, where collected data is processed and fused, in order to provide complete information of the area and the road users in nearly real-time conditions. All platforms in the network transmit their processed data (detections), along with their GPS-based position. This complete picture of the area and potential hazards are transmitted back to the subscribed platforms in the network and to other registered mobile platforms (that do not necessarily have onboard sensors). The proposed approach allows to extend the field-of-view of each sensor beyond the line-of-sight.

The system provided by the present invention improves the traffic safety of mobile platforms in multiple ways. When the sensors on the adjacent vehicles share their detections, they observe the same obstacles from multiple points of view. Thus, the fusion of this information can enable super-resolution imaging of the obstacles, needed for their reliable avoidance. When measurements of the geographically distributed sensors (such as radars) are fused in the cloud central processor, they create a long-range (global) situation awareness (contrary to the currently available only local information).

This approach enables multiple applications for more efficient navigation, parking spot location for automotive platforms, weather-aware-based navigations, and others. This approach also allows to avoid mutual interferences from radars on adjacent platforms by adaptively controlling their transmission power, and providing immunity to cyber-attacks. In addition, the collected data in the cloud can be used for big-data applications (data that contains greater variety, arriving in increasing volumes and with a higher velocity rate, at which data is received and acted on).

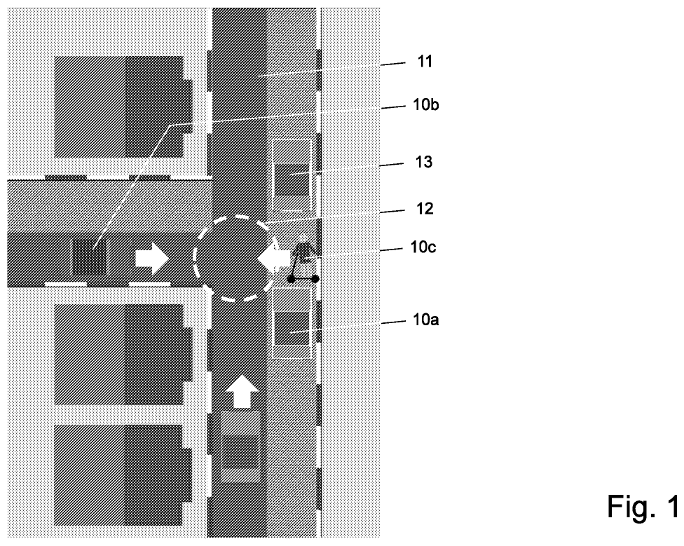

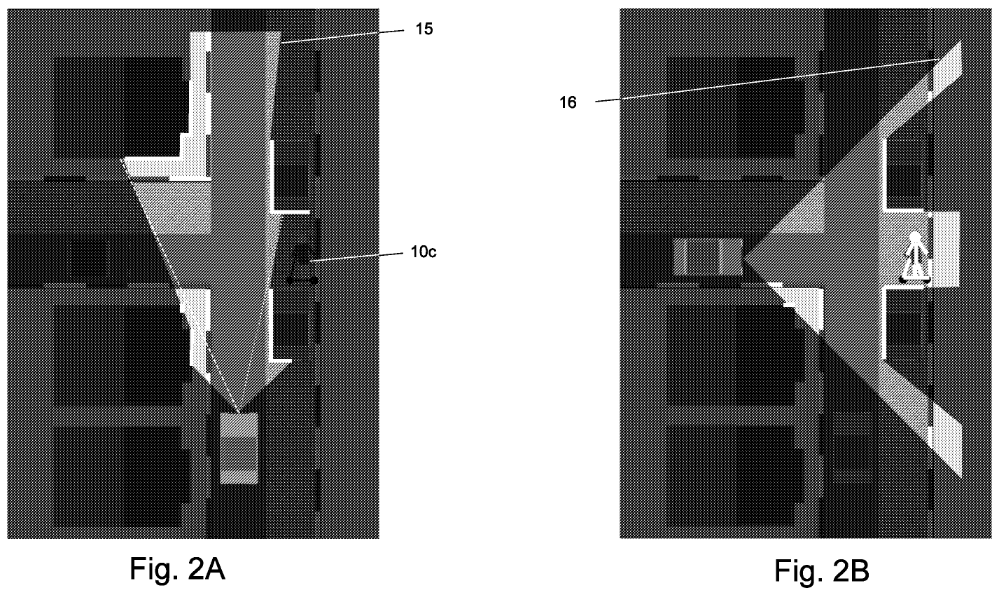

FIG. 1 illustrates a situation when buildings block the visibility of a driver in an urban area. In this situation, a vehicle 10a travels along a road in an urban area toward a junction 12. Another vehicle 10b approaches the same junction from the left. A scooter 10c with a rider approaches the junction from the walkway on the right side, between two parking vehicles, 13 and 14 (or between adjacent buildings). Scooter 10c cannot be seen by vehicle 10a, but is clearly seen by vehicle 10b. This situation is illustrated in FIG. 2A, which shows the field of view of vehicle 10a. It can be seen that the field of view 15 of vehicle 10a is truncated and excludes the scooter 10c. On the other hand, FIG. 2B shows the field of view of vehicle 10b. It can be seen that the field of view 16 of vehicle 10a is complete and includes the scooter 10c.

The system provided by the present invention includes algorithms for the efficient fusion of measurements from multiple sensors (such as radars) in a central computational cloud. The proposed algorithm is based on the construction of the global likelihood function (with the greatest likelihood) of various objects in the area, and it considers the limited accuracy of the GPS-based position and orientation of each vehicle, as well as the latency of the data transferred from each vehicle to the cloud. The central processor fuses the received information (in the form of point clouds, for example, which are discrete sets of data points in space. The points may represent a 3D shape or object) from all the sensors (or radars), and estimates 3D positions and 2D velocity of the detected targets. In addition, the system implements tracking algorithms to provide an estimation of velocities and accelerations, and allows accurate prediction of different scenarios over time. The proposed system provides an additional layer of the digital radar map of the traffic scene extracted by the information collected from other radars in the scene. The fusion efficiency may be increased by measuring the relative location of the detected proximal objects.

The fusion of multiple detections obtained from geographically distributed sensors allows to improve the localization accuracy and resolution. The output of the fusion process is the hit-map (a hierarchical topological map representation for navigation in unknown environments) on the global digital map that can be broadcast back to all the subscribed vehicles in the area to: a) layer provide them with additional information beyond their individual sensing horizon, b) improve their detection robustness, localization accuracy, and spatial resolution, c) control their transmit signals to avoid mutual interferences, and d) improve sensing performance by adapting transmit waveform to the sensed scene according to information from other sensors. Automotive radar companies and vehicle manufacturers are interested to obtain the global map produced by this system. These companies invest a lot in order to obtain high resolution radars. The proposed solution allows them using simpler radars with lower accuracies and resolution and obtain much better results. In addition, they can use lower transmit power, and thus, reducing mutual interference.

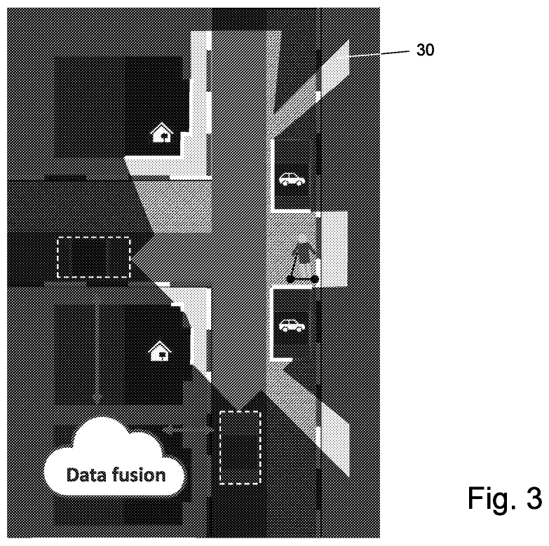

FIG. 3 shows the result of data fusion of the radar measurements (or radar map) taken by both vehicles 10a and 10b. It can be seen that after each of the vehicles shares its radar map and uploaded it to the computational cloud, the unified map 30 includes the scooter 10c, which is now visible. The unified map 30 (which is a result of the data fusion from both vehicles, processed by the computational cloud) is transmitted in real-time to vehicle 10a, or to any other subscribed vehicle. As a result, a potential risk to scooter 10c has been avoided. It should be indicated that the automatic sharing of the radar maps of each vehicle, the data fusion and the transmission of the sharing result to the relevant vehicles must be performed in real-time (or near real-time), to allow the drivers of the relevant vehicles to rapidly react and avoid accidents. By measuring the location of each subscribed vehicle, on the enriched global map, it is possible to measure the relative location of each vehicle and perform fast synchronization between the radar signals, to ensure high accuracy.

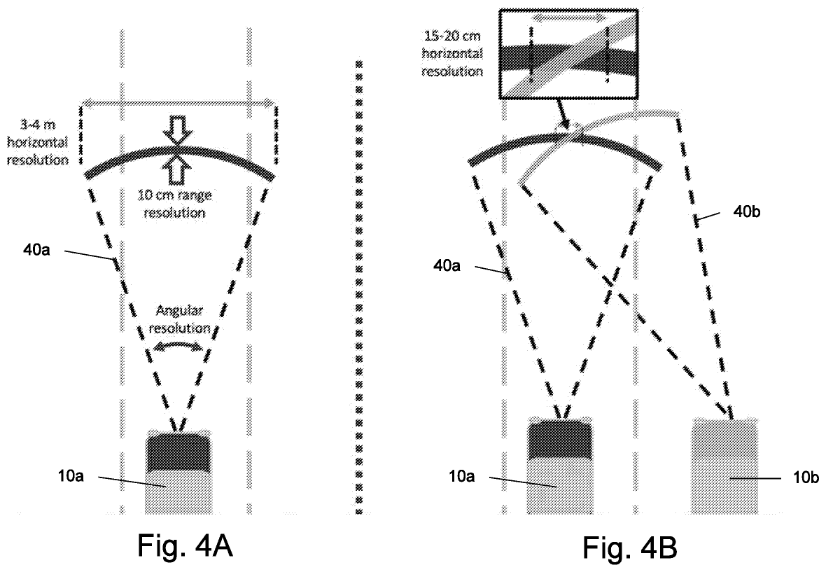

FIGS. 4a and 4b illustrate the advantage of sharing radar maps and data fusion, in terms of improved resolution, both in range and angular resolution (azimuth). FIG. 4A shows the field of view of a radar sensor of a single vehicle 10a. It can be seen that the (vertical) resolution in range is very high (about 10 cm), but the horizontal resolution (resulting in angular resolution) is low (about 3-4 m). FIG. 4B illustrates the improvement in the horizontal resolution as a result of sharing the radar maps. If another vehicle 10b detects the same target from a different field of view 40b, the two fields of view overlap and the horizontal resolution is dramatically improved (to be about 15-20 cm).

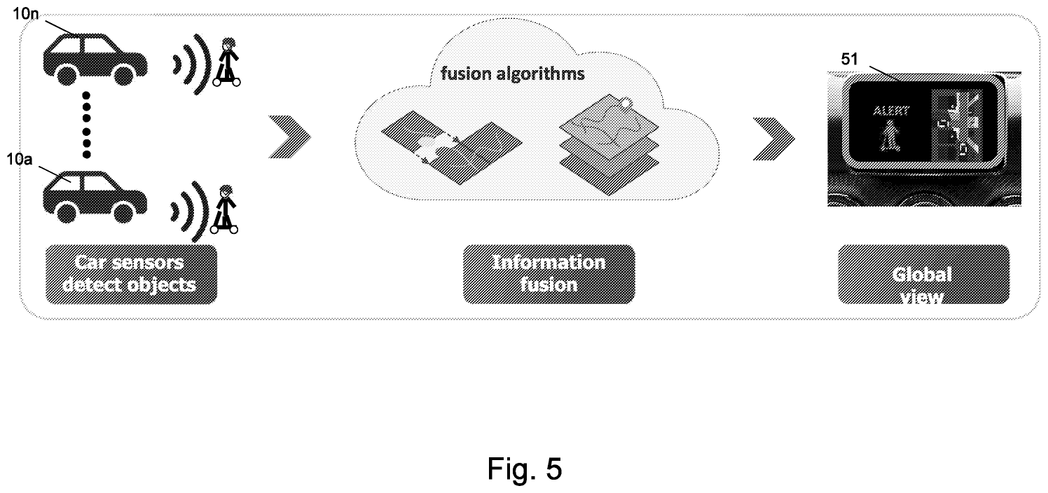

FIG. 5 illustrates the data flow in the system, according to an embodiment of the invention. At the first step, the data acquired by the sensors of each subscribed vehicle 10a, . . . , 10n is shared by periodically transmitting the map (such as a radar map) to a remote server or a computational cloud 50. At the next step, the shared data is jointly processed to obtain data fusion that enriches the built map at the computational cloud 50. At the next step, the enriched global map 51 is transmitted and displayed in the relevant vehicles. The entire process is performed near real-time. For example, if a 4G cellular infrastructure is used for sharing and transmission, the data has a latency of about 50 mS. If a 5G cellular infrastructure is used for sharing and transmission, the data has a latency of about 1 mS. Since the average reaction time of the driver ranges between 390-600 mS, the driver will receive the enriched global map 51 much faster that his reaction time and will be able to take the necessary actions to prevent an impending accident. The enriched global map 51 may include an alert in the form of a visual indication or a voice indication. For example, a detected object (a scooter, a bike or a pedestrian) may appear as a blinking icon on the enriched global map, accompanied with a voice alert in the form of a beep or a voice announcement (such as “a scooter approaching on the right”).

In addition, the enriched global map can be helpful also for automatic hazard detection on the road and automatically sharing this information with the subscribed vehicles.

In another embodiment, the system provided by the present invention will be adapted to collect data from various sensors, such as infrastructure radars and other moving radars (e.g., radars and sensors that are installed on drones) and fuse their shared information.

The data stream from each sensor to the central processor (at the cloud or the remote server) includes a timestamp with an accuracy of better than 100 msec. The data stream may also include additional data, such as a list of detected targets (along with range, azimuth, elevation, radial velocity and intensity), a confidence level of the detected targets and a GPS position of the sensor (such as radar) radar, odometry or other sensors, and the radar orientation. The additional data may be used to reduce the amount of processing that is required to generate the enriched global map.

The system provided by the present invention can identify and classify the targets, including fused point clouds, from distributed targets (radar targets that are large compared with the pulse volume, which is the cross-sectional area of the radar beam multiplied by one-half the length of the radar pulse). The classification is significantly improved due to radar measurements of the same object from various aspects by a plurality of moving vehicles in the vicinity of the object. The data fusion of the system also significantly improves detection performance by increasing the probability of detection and reducing the false alarm rate. The system also significantly improves the target localization accuracy and resolution in all dimensions, which results in higher safety. The fusion of data collected from the sensors of multiple vehicles allows extending operation range beyond the detection range of a single radar, as well as and field-of-view beyond the line-of-sight.

The system of the present invention can provide very accurate positions (of about 0. I-0.2 m) of the subscribed vehicles in the network, which is substantially better than the accuracy of GPS. In automotive applications, this high accuracy can be used for lane change alert, which is currently performed only by cameras that are sensitive to bad lighting and weather conditions. Therefore, the system can provide traffic information in the resolution of road lanes that can be used to allow the vehicles to autonomously navigate between the lanes.

It is impossible to produce coherent spoofing attacks toward all spatially distributed radars. The system of the present invention can also provide immunity of automotive radars against radar cyber-attacks such as jamming and spoofing. Jamming attacks that are observed from different directions can be easily detected and localized. By analyzing the echoes from multiple radars, the system can detect jamming and spoofing attacks, as well as to localize the exact jammer locations. In addition, the information on jamming and spoofing attacks and the locations of their sources can be reported to official authorities.

According to another embodiment, the fused information will be used to evaluate the confidence level of the radar (or sensor) in the fusion process, by assessing bias and variance for the measurements of each radar regarding range, azimuth, elevation and Doppler estimations. By using the Doppler information from multiple directions, the system can provide accurate 2D velocity of the sensed objects. The system can also provide performance assessment of the sensors (such as radars) over time by comparing the detections from the different sensors to the fused information. In case of performance degradation of specific radars, the system will be able to provide malfunction alerts (such as alerts regarding the probability of detection and false alarms, as well as the accuracy of azimuth, elevation, range and Doppler effect) to the automotive radars (or sensors).

One of the challenges of automotive radars (or sensors) is the detection and localization of small obstacles. Due to their small radar-cross-section, these objects may be detected in short range only. After the detection of such an obstacle by at least one radar (or sensor), other vehicles approaching the obstacle can get hazard alerts, in advance, much before reaching the detection range of their radars (or sensors). These objects may be dynamic (e.g. animals crossing the road), and thus they can be tracked over time. In addition, reports on such hazards will be sent to the authorities.

Crossing vehicles with Non-Line-Of Sight (NLOS) can be detected using infrastructure radars, such as radars located in junctions or on roads at turning points. The locations and velocities of the crossing vehicles are used to predict the exact time of the presence of the vehicle in the junction and provide alerts accordingly. Additional alerts may be sent in real-time to pedestrians, regarding vehicles which may risk them.

By estimating the propagation loss, the system can accurately evaluate in real-time the precipitation rate (of rain or snow) at different positions. Real-time alerts can be made for different vehicles. This information can also be reported to meteorological services. Automotive radars can provide such information in large volumes and more geographically spread.

According to another embodiment, the system can use automotive radars to detect vacant parking slots, along the vehicle's path. This information can be collected and distributed to the vehicles.

According to another embodiment, the information from additional automotive radars may be used to implement low-cost radars (with lower transmit power and lower complexity) without degradation in performance. Also, multipath-induced “ghost” targets (which result in “ghost” targets and increase the probability of false alarms when operating near smooth reflecting surfaces, such as guard rail and buildings) can be eliminated, thereby reducing the probability of false alarms. In addition, the system can resolve the mutual interference problem by appropriate spatial and spectral resource allocation to minimize the mutual interferences (as radars share the same spectrum and thus mutually interfere with each other, resulting in degraded detection performance, elevated false alarm rates, and degraded localization accuracy). The system can also use the information from adjacent vehicles and infrastructure radars, to provide the sensing information to all vehicles in the area, including vehicles that do not have sensing capabilities.

According to another embodiment, the system can generate an enriched global roads map which includes obstacles and blockages, and can be established and periodically updated. The data collected from multiple radars (or sensors) over time can be used for autonomous driving, can improve the navigation accuracy, and can be reported to authorities.

As various embodiments and examples have been described and illustrated, it should be understood that variations will be apparent to one skilled in the art without departing from the principles herein. Accordingly, the invention is not to be limited to the specific embodiments described and illustrated in the drawings.

1. A method for generating and providing an enriched global map to subscribed moving platforms, comprising:
a) collecting data containing detection maps from sensors installed on a plurality of moving platforms in a given area, where each sensor views a target of an object of interest from a different angle;
b) generating an enriched and complete high-resolution global map of said given area by jointly processing and fusing the collected data that unifies the detection capabilities of said moving platforms; and
c) transmitting said complete high-resolution global map to at least one moving platform.

2. The method according to claim 1, wherein joint processing and fusing of the collected data is done by a central processor, a remote server or a computational cloud, being in communication with the plurality of moving platform over a wireless data network.

3. The method according to claim 2, wherein data fusion is done to improve the range resolution and the angular resolution and to provide accurate positioning of moving platforms and objects, based on the construction of global likelihood function of various objects in the area, while considering the accuracy of the GPS-based position and orientation of each moving platform, and the latency of the data transferred from each moving platform to the computational cloud.

4. The method according to claim 1, wherein the collected data is in the form of point clouds.

5. The method according to claim 1, wherein the fusion efficiency is increased by measuring the relative location of detected proximal objects.

6. The method according to claim 1, wherein high accuracy is obtained by measuring the relative location of each moving platform and performing fast synchronization between the signals.

7-9. (canceled)

10. The method according to claim 1, wherein the enriched global map includes an alert in the form of a visual indication or a voice indication, to be used for automatic hazard detection on the road.

11. The method according to claim 1, wherein the alert appears as a blinking icon on the enriched global map, accompanied with a voice alert in the form of a beep or a voice announcement.

12. (canceled)

13. The method according to claim 1, wherein data is collected from automotive radars, infrastructure radars and other moving radars.

14. The method according to claim 1, wherein the data stream transmitted from each moving platform to the central processor includes a time stamp with predefined accuracy.

15. The method according to claim 1, wherein the data stream further includes one or more of the following:
a list of detected targets;
a confidence level of the detected targets;
a GPS position of the sensor;
odometry or other sensors;
the sensor's orientation.

16-17. (canceled)

18. The method according to claim 1, further comprising one or more of the following:
providing traffic information in the resolution of road lanes, for allowing vehicles to autonomously navigate between the lanes;
providing immunity of automotive radars against radar cyber-attacks such as jamming and spoofing;
using the fused information to evaluate the confidence level of the radar in the fusion process, by assessing bias and variance for the measurements of each radar regarding range, azimuth, elevation and Doppler estimations.

19-20. (canceled)

21. The method according to claim 1, further comprising one or more of the following steps:
providing a performance assessment of the radars over time by comparing the detections from the different radars to the fused information;
using the locations and velocities of the crossing vehicles to predict the exact time of the presence of the vehicle in a junction and provide alerts;
evaluating precipitation rates (of rain or snow) at different positions by estimating the propagation loss;
detecting vacant parking slots, along the vehicle's path.

22-24. (canceled)

25. The method according to claim 1, further comprising using the information from adjacent vehicles and infrastructure radars, to provide sensing information to all vehicles in the area, including vehicles that do not have sensing capabilities.

26. The method according to claim 1, wherein the sensors are selected from the group of:
radars;
cameras;
LiDARs.

27. The method according to claim 1, wherein the moving platforms are selected from the group of:
vehicles;
bikes;
drones;
scooters;
pedestrians.

28. A system for generating and providing an enriched global map to subscribed moving platforms, comprising:
a) a plurality of sensors installed on a plurality of moving platforms in a given area, where each sensor views a target of an object of interest from a different angle;
b) a data network for collecting data containing detection maps from said sensors;
c) a central processor, connected to said data network, for:
c.1) generating an enriched and complete high-resolution global map of said given area by jointly processing and fusing the collected data;
c.2) unifying the detection capabilities of said moving platforms; and
c.3) transmitting, over said data network, said complete high-resolution global map to at least one moving platform.

29. The system according to claim 28, wherein the computerized system is a server or a computational cloud.

30. The system according to claim 28, in which data fusion is done, based on the construction of global likelihood function of various objects in the area, while considering the accuracy of the GPS-based position and orientation of each vehicle, and the latency of the data transferred from each vehicle to the computational cloud.

31-35. (canceled)

36. The system according to claim 28, used for detecting vacant parking slots, along the vehicle's path.

37-38. (canceled)
